(19) United States
(12) Patent Application Publication
(10) Pub. No.: US 2013/0305272 A1
(43) Pub. Date: Nov. 14, 2013

(54) PROCEDURE, APPARATUS, SYSTEM, AND COMPUTER PROGRAM FOR VIDEO ADDRESSABLE ADVERTISING

(71) Applicants: Kenneth D. Fullett, Naperville, IL (US); Pankaj Shroff, Nashua, NH (US)

(72) Inventors: Kenneth D. Fullett, Naperville, IL (US); Pankaj Shroff, Nashua, NH (US)

(73) Assignee: TELLABS OPERATIONS, INC., Naperville, IL (US)

(21) Appl. No.: 13/475,683

(22) Filed: May 18, 2012

Related U.S. Application Data
(60) Provisional application No. 61/646,796, filed on May 14, 2012.

(51) Int. Cl. H04N 21/24

(52) U.S. Cl. 725/14

(57) ABSTRACT

A procedure for selecting targeted content, and a computer program, apparatus, and system that operate in accordance with the procedure. The procedure includes monitoring a user's activity in a first type of provided service, and selecting content from a second type of provided service, based on the monitoring. In one example the first type of provided service is a data service, the second type of provided service is a video service, and the user's activity includes web browsing. Also in one example, the content includes advertising content, such as in video form, and such content is selected based on a user interest profile generated based on the user's activity.

### CROSS REFERENCE TO RELATED APPLICATION

The present application claims the benefit of priority under 35 U.S.C. 119(e) of U.S. Provisional Patent Application No. 61/646,796, filed May 14, 2012, the content of which is incorporated by reference herein in its entirety, as if set forth fully herein.

### BACKGROUND

1. Field

Example aspects described herein relate to addressable advertising, and, more particularly, relate to procedures, apparatuses, systems, and computer programs that enable advertisement placements to be made based on a user's interest profile.

2. Description of Related Art

The collection of data, followed by the analysis of it for use in decision making, is called “analytics”. In the telecommunications industry, the term analytics is commonly used to reference three forms of analytics: network, subscriber, and web analytics.

Network analytics is concerned with the performance of a telecommunications network including how and when a network is being utilized. Network analytics is typically used for network planning and diagnostics.

Subscriber analytics focuses on how and when a specific subscriber is interacting with the network. Subscriber analytics is typically used to offer personalized services such as tiered service plans with rate and usage limits, possibly based on time-of-day and application, enforce fair-usage, and as a tool to offer personalized services based on subscriber behavior and utilization.

The focus of web analytics is on how subscribers accessing websites, called visitors, are interacting with websites and web applications. Web analytics is used to identify the pages viewed by visitors, how they landed on the page, their click-path through the website, and the like. This information is then used by publishers, marketers, and others to optimize the visitor's experience and to improve the conversion effectiveness of the website.

Service providers such as cable companies provide multiple channels to subscribers via the services provided by the providers, such as data (internes service), voice (e.g., fixed line and mobile telephony), and video (e.g., linear TV, and video-on-demand (VoD)).

Addressable advertising provides an ability to select advertisements that will be of greater interest to a subscriber based on information about the subscriber (e.g., subscriber analytics), such as demographic information and subscriber interests. An advertisement selected in this manner is often referred to as a targeted advertisement. Conventionally, selection of video advertisements has been done based upon static information (e.g., subscriber location) that may have been collected over time, rather than based upon dynamic information.

### SUMMARY

Existing limitations associated with the foregoing, and other limitations, can be overcome by a procedure for selecting targeted content, and by an apparatus, computer program, and system that operate in accordance with the procedure.

In one example embodiment herein, the procedure comprises monitoring a user's activity in a first type of provided service, and selecting content from a second type of provided service, based on the monitoring. The procedure also can comprise providing the content to the user. In one example embodiment, the first type of provided service is a data service, and the second type of provided service is a video service, although the services may be different than those in other embodiments.

Further in accordance with an example embodiment herein, the providing includes providing the content to the user in association with one of a video on demand (VoD) video and a liner video, and the user's activity includes web browsing.

In accordance with an additional embodiment herein, the first type of provided service is provided over a first channel, and the second type of provided service is provided over a second channel.

In one example embodiment herein, the procedure further comprises providing an interest profile based on the monitoring, and the selecting is performed based on the interest profile.

In accordance with another example embodiment herein, the procedure further comprises providing an interest profile in response to a user request associated with the second type of provided service, and the selecting is performed based on the interest profile.

In still a further example embodiment herein, the procedure further comprises providing an interest profile at one or more predetermined times, and the selecting is performed based on the interest profile.

The content selected in the procedure can be any suitable type of content, and in one example includes advertising content, such as in video form (although it may be in another form).

The selecting can include correlating the user's activity to the content. In one example, the correlating includes correlating at least one webpage visited by the user as part of the user's activity, to at least one corresponding category of content.

By virtue of the procedure herein, data obtained from a subscriber's data channel can be used to provide targeted advertisements on the subscriber's video channel (i.e. cross channel addressable advertising). The example aspects described herein are unlike traditional systems which are not geared toward cross-channel functionality and are web based rather than service provider based. Existing solutions also are not cross-channel-based. The procedure herein enables ad placement decisions to be made based on users' interest categories/profiles while protecting user privacy. Users can be provided with relevant ads, while advertisers are enabled to reach their target audiences in more precise and relevant ways, by virtue of the example aspects herein.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a representation of an example communication network that is constructed and operated in accordance with at least one example aspect herein.

FIG. 2 is another representation of an example communication network, that may include at least some of the components of the network of FIG. 1.

FIG. 3 is an example interaction diagram that illustrates a procedure in accordance with an example embodiment described herein, relating to addressable advertising in a video context, such as video on demand (VoD).

FIG. 4 is an example interaction diagram that illustrates a procedure in accordance with an example embodiment described herein, relating to addressable advertising in a video context.

FIG. 5 is an architecture diagram of a processing system in accordance with an example embodiment described herein.

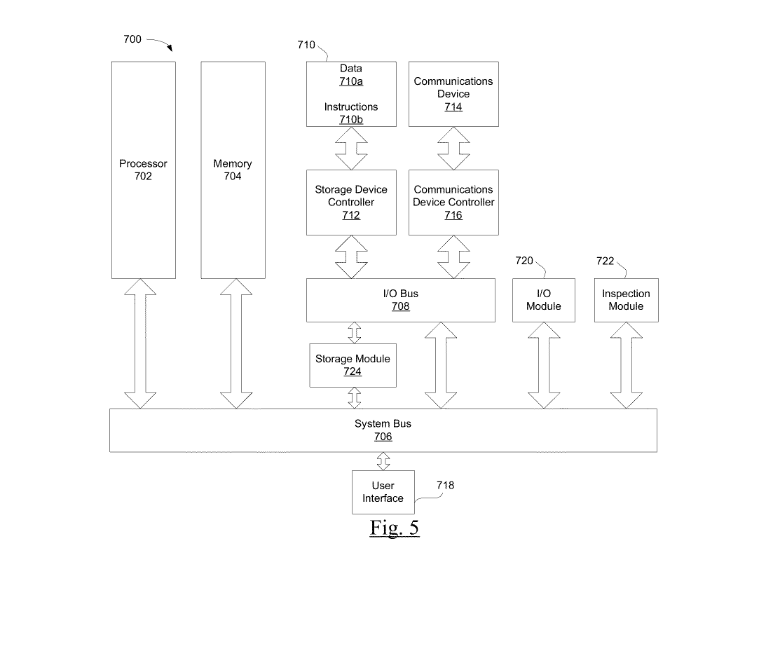

### DETAILED DESCRIPTION

Presented herein is a novel and inventive method, and a system, apparatus, and computer program that operate in accordance with the method, to provide addressable content, such as, by example only, advertising content, for video including linear and video on demand (VoD), or other types of video or media besides video. Addressable advertising is the ability to choose advertisements that will be of greater interest to a subscriber based on information about the subscriber. Such information may include, by example only, demographics and interests. Content such as, for example, advertisements chosen in this fashion is referred to as targeted content (e.g., targeted advertisements).

According to one example aspect herein, data obtained from a subscriber's data channel (or other type of service channel) is used to provide targeted advertisements on the subscriber's video channel (i.e., cross channel addressable advertising), or another type of service channel.

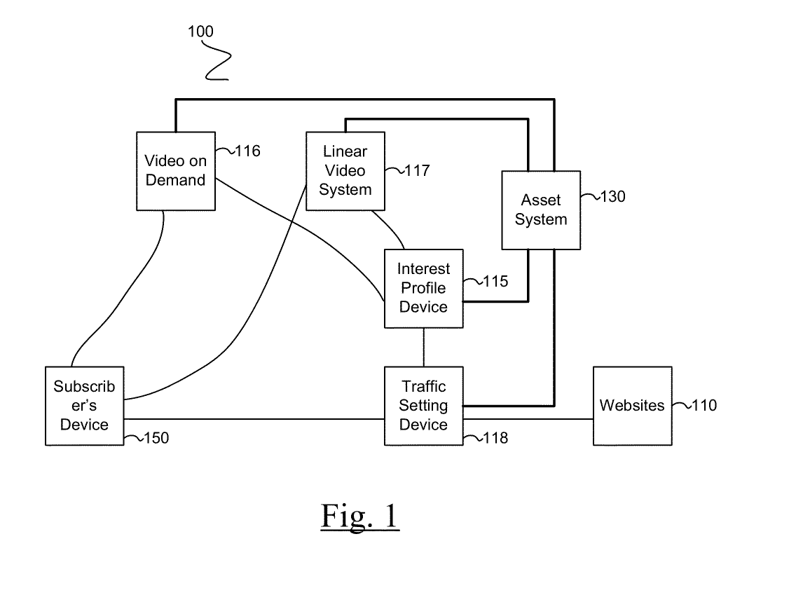

Referring to FIG. 1, an example communication network that is constructed and operated in accordance with at least one example aspect herein will now be described. The network 100 includes a plurality of user communication terminals (also referred to for convenience as “subscriber devices”), such as information appliances 150 (for convenience, only one information appliance 150 is depicted in FIG. 1), each of which is bidirectionally communicatively coupled to one or more web servers 110. At least one traffic “sniffing” device 118 is arranged to “sniff” or snoop traffic communicated between the appliance 150 and web server 110. In one example embodiment, the device 118 inspects traffic passing between the elements 150 and 110, at a switch (Ethernet switch) (not shown) that duplicates the traffic over a mirror port. The inspection by the device 118 can occur at one or more protocol layers (e.g., one or more of the GTP, IP, TCP, HTTP, and HTML protocol layers, or other predetermined layers of interest), such as Layer 4 and/or Layer 7 of the HTTP protocol layer, and can identify various type of information such as, for example, the subscriber's identity (e.g., the subscriber's currently assigned IP address¹, IMSI, or other predetermined identifier, each of which is also referred to herein as a subID) and a predetermined identifier (e.g., a URI or URL) of a host server 110. ¹If NAPT is in use, the inspection can occur prior to the NAPT to preserve the identity of the subscriber.

The traffic sniffing device 118 is bidirectionally communicatively coupled to one or more interest profile devices 115 (also referred to as a codebook server 115), which, in turn, is bidirectionally communicatively coupled to each of at least one video-on-demand (VoD) system 116 and at least one linear video serving system 117, wherein each element 115, 116, 117 includes, for example, one or more servers, databases and/or the like. In one example embodiment, the system 116 provides information content, such as that offered by a VoD service, to the appliance 150, and the system 117 provides information content, such as, for example, that offered by a linear video service, to the appliance 150.

Program code on device 118 also tracks a visitor's (e.g., a user of appliance 150) click-by-click navigation of a website. Typically recorded are a landing page, the referring website, pages and the order visited during a session (called the click-path), time spent on a page, subscriber's registration, and purchasing activity. In one example embodiment, this information is not stored, and no browsing history is maintained, although in other example embodiments the information is stored to a database, such as database within or associated with device 115. Using a visualization tool with the database, an analyst can determine both current activities in real time and analyze long term trends.

In one example embodiment, interest profile 115 connects to the device 118 (e.g., at Ethernet switch) via two separate interfaces, one connected to a mirror port of the switch for monitoring and a second connected to the switch for GUI management and SIS queries, for example. Based on a visitor's recent web browsing session, the interest profile device 115 can create a visitor's codebook keyed to identification information about the visitor, such as the visitor's IP address or other identifying information. An asset system 130, such as a video ad system, can query the device 115 for the visitor's codebook using the visitor's identification information. The system 130 can select the most appropriate content (such as advertisement(s)) by matching one or more codebook categories with the available content, as will be described further below.

In one example embodiment, the interest profile device 115 derives a subscriber interest profile (codebook information) periodically or otherwise using predetermined algorithms, based on information obtained from the traffic sniffing device 118. For example, based on the inspected traffic, the device 115 first categorizes web pages visited by the visitor into predefined codebook categories. This may be performed on a periodic basis (e.g., every two weeks or otherwise), or each time the device 115 receives information from the device 118, although these examples are non-limiting. The following Table 1 represents an example of correlated websites and codebook categories.

TABLE 1
Example Codebook to Website Category Mapping

| | Codebook |
|---|---|
| Website | Category |
| Pet website 1 | Shopping - |
| | Pets |
| Children's apparel website 1 | Shopping - |
| | Children Apparel |
| Children's apparel website 2 | Shopping - |
| | Children Apparel |
| Men's apparel website 1 | Shopping - |
| | Mens Apparel |
| Skin care website 1 | Skin Care - |
| | Defined Facial |
| Paper towel website 1 | Paper Products/ |
| | Paper Towels |
| Website-n | Category-n |

In one example embodiment, the interest profile device 115 can operate to create interest profiles and perform analytics and the like, in the manner described in U.S. patent application Ser. No. 12/813,999, filed Jul. 11, 2010, entitled “Procedure, Apparatus, System, and Computer Program”, by Kenneth Fullet (see, e.g., analytics server 118), and a visitor's web interactions can be tracked in the manner described in that application. The contents of U.S. patent application Ser. No. 12/813,999 are incorporated by reference herein their entirety, as if set forth fully herein.

In the illustrated example, asset system 130 is in communication with the interest profile device 115 and the subscriber 150 (this may be by way of device 118, as shown). In another example, the functionalities of the system 130 can be included in or more of the elements 115, 116, 117, and thus there need not be a separate system 130.

The system 130, which may include one or more servers and related database(s), stores codebook categories (provided in codebook information from device 115) in correlation with predetermined, related categories pre-assigned to predetermined content, such as, for example, advertising assets (e.g., a link to an advertising video or webpage). The following Table 2 represents an example of codebook categories (see under “Codebook Categories”) and associated categories (e.g., see under “Product Category”) assigned to advertising assets (see under “File”), that may be stored on or in association with system 130.

TABLE 2
Advertising Asset Information

| | Product | Codebook | | |
|---|---|---|---|---|
| Name | Category | Categories | Notes | File |
| A Pur | Air Freshener | Shopping - | Plug-in | APur.wmv |
| | Deodorizer | Pets | freshener | |
| | Home Scents | | | |
| | Home | | | |
| | Fragrance | | | |
| Asoap | Laundry Soap | Shopping - | Tennis guy | Asoap.wmv |
| | | Children | with dirty | |
| | | Apparel | shirt | |
| Dsoap | Laundry Soap | Shopping - | Tough Guy | Dsoap.wmv |
| | | Children | with dirty | |
| | | Apparel | shirt | |
| Razor | Personal | Shopping - | Gym, men | razor.wmv |
| company | Care/Razor | Mens | shaving. | |
| | Blades | Apparel | | |
| Shampoo | Shampoo | Shopping - | What's on | shampoo.wmv |
| company | | Mens | your mind | |
| | | Apparel | sports guy. | |
| No Wrinkle | Skin Care - | Shopping - | Woman anti- | NoWrinkle.wmv |
| | Defined Facial | Womens | wrinkle | |
| | | Apperal | | |
| Complete | Skin Care - | Shopping - | Woman in | skincare.wmv |
| Skin Care | Defined Facial | Womens | Salon. SPF | |
| | | Apperal | | |
| Toothpaste | Toothpaste | Dining | Elegant bath, | toothpaste.wmv |
| Company | | | toothbrush | |
| | | | and | |
| | | | toothpaste | |
| Paper | Paper Products/ | Cooking | Goofy man in | papertowels.wmv |
| Towels | Paper Towels | | tights at | |
| Company | | | wedding | |
| Car Gallery | Auto | Automotive - | | Cardealer.wmv |
| (Dealer) | | New | | (car) |
| Sports | | Sports | basketball | basketball.wmv |
| | | | game | (sports) |
| Sports | | Sports | Sports | baseball.wmv |
| Tonight | | | Programming | (sports) |

In one example embodiment, each advertising asset is pre-assigned to a particular category (e.g., a Product Category) and one or more codebook categories. In accordance with an example aspect herein, information regarding a visitor's browsing, such as, for example, hyperlinks of webpages visited by the visitor and detected by the traffic sniffing device 118, are mapped to codebook categories (e.g., by the device 115 using Table 1 above) that are, in turn, mapped to the categories assigned to the advertising assets (by, e.g., the device 115 and/or system 130 using Table 2 above). For example, in a case where the traffic sniffing device 118 detects that a visitor visits a landing page of “Pet website1”, then the interest profile device 115 correlates that website information to codebook category “Shopping-Pets” (Table 1), and then that category is correlated to advertising asset information “APur.wmv” in Table 2.

Also, in one example embodiment, the device 115 maintains a record of each visitor (or a household associated with a visitor/subscriber), as determined based on information identifying the subscriber included in the traffic sniffed by the device 118, and scores the subscriber against the individual codebook categories to create an interest profile for the subscriber. Such information can be monitored and updated over time, such as, in one example, every two weeks, or each time the visitor is determined to visit a webpage. For example, if a particular subscriber is determined by the server 115 to visit webpages within the “Sports” category more often than those in the “Automotive” category, then the device 115 scores the “Sports” category higher than the “Automotive” category. Thus, the device 115 can generate an interest profile for the particular subscriber, that identifies the categories of the sites most visited by the subscriber, as well as a list that includes the categories in which the visitor is most interest, down to those in which the visitor is least interested. The manner in which the device 115 can make these determinations can be in accordance with any suitable existing or later developed analytics techniques.

Also, in accordance with an example embodiment herein, each advertisement is mapped to the codebook category with particular related content, such as a story or the like. Table 3 below represents one example of how codebook categories may relate to content, such as that under the “Story” heading.

TABLE 1
Advertising Asset to Codebook Mapping Stories

| | Codebook | | |
|---|---|---|---|
| Name | Categories | Story | Marketing |
| A Pur | Shopping - | We need to get some pet | People with pets use |
| | Pets | supplies for the dog or | deodorizers |
| | | cat. The smell of the | |
| | | wet hairy dog and the | |
| | | smelly cat come to | |
| | | mind. Of course these | |
| | | problems can be solved | |
| | | with Ambi Pur yielding | |
| | | a breath of fresh air that | |
| | | everyone in the family | |
| | | will enjoy. | |
| Asoap | Shopping - | After we figure out what | People with children |
| | Children Apparel | pet supplies that we | need high quality |
| | | need, we need to pick | laundry detergents to |
| | | up some clothes for the | extend the life of their |
| | | kids-they always make | children's clothing. |
| | | a mess of their clothes | |
| | | with playing sports and, | |
| | | well, just being kids. | |
| | | We need a good laundry | |
| | | detergent to solve that | |
| | | problem. | |
| Dsoap | Shopping - | Rotate Asoap and | |
| | Children Apparel | Dsoap ads. | |
| Razor | Shopping - Mens | I'm going out on a date, | Men that buy nice |
| Company | Apparel | but I need to pick up a | clothes want to look |
| | | new shirt first. I want | good too. |
| | | to make sure that I look | |
| | | my best for the date. | |
| Shampoo | Shopping - Mens | Rotate with razor | |
| Company | Apparel | company ad. | |
| No- | Shopping - | I need to get some new | Woman that life |
| Wrinkle | Womens Apparel | clothes for work. I'm | fashion like to pamper |
| | | going to look at some of | and take care of |
| | | the latest fashions to see | themselves. |
| | | if anything looks | |
| | | interesting. | |
| Complete | Shopping - | Rotate with No-Wrinkle | |
| Skin Care | Womens Apparel | Company ad | |
| Toothpaste | Dining | Looking for carryout or | |
| Company | | a place to go for dinner. | |
| Paper | Cooking | You like to cook, so | If you cook, you use |
| Towel | | you're looking at | paper towels. |
| Company | | cooking sites; but, you | |
| | | likely not to buy paper | |
| | | towels on line preferring | |
| | | to pick those up at the | |
| | | local grocery store. | |
| Car | Automotive - | I'm buing a new car! | Auto fan |
| Gallery | New | I'm looking at all sorts | |
| (Dealer) | | of car information. | |
| Sports | Sports | I'm a sports fan. I'll | Sports fan |
| | | take sports in any form. | |
| | | I'm checking my | |
| | | favorite sports teams | |
| | | on-line. | |
| Sports | Sports | Rotate with Sports ad. | Sports fan |
| Tonight | | | |

Also, in one example embodiment, a summary of a protocol stack for communications provided between the device 115 and system 130 is as represented in Table 4 below, although that example is for purposes of illustration and should not be construed as being limiting to the invention.

TABLE 3
Codebook Server - SCTE SIS Protocol Stack Summary

| Component | Description |
|---|---|
| SCTE-130-6 | A subset of the SCTE130-6 capabilities can be |
| | utilized. SCTE130-6 messages are XML based and |
| | are enclosed within SOAP envelope messages. |
| SOAP | A SOAP 1.1 message is an ordinary XML document. |
| Transport | It contains an envelope element, header, body |
| | and fault element. Body element contains the |
| | various SCTE 130-6 messages. SOAP message can |
| | be carried over any transport protocol such as |
| | HTTP, SMTP and TCP. |
| HTTP | Message delineation of the TCP stream can be |
| | handed by the HTTP 1.1 layer. |
| TCP | TCP provides reliable, ordered, rate |
| | controlled, data transfer. |
| IP | IPv4 |
| Ethernet Link | |
| Layer | |
| Ethernet | Various Ethernet physical interfaces are |
| Physical | supported dependent upon the deployed |
| | hardware. |

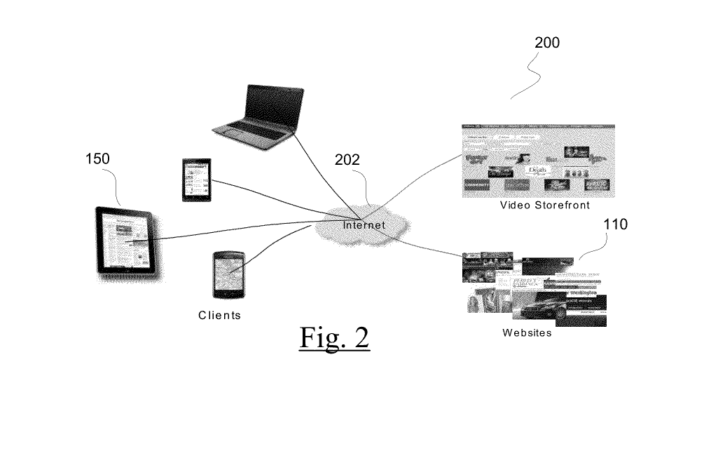

FIG. 2 shows an example communications network 200 that is constructed and operated in accordance with an example aspect herein, and which may include one or more components of the network 100 of FIG. 1. The network 200 includes information appliances 150, each of which is bidirectionally communicatively coupled to one or more networks 202 (wireless or wire line, fixed or mobile) such as the Internet, a WAN, LAN, and/or another type of network, and also shows one or more web servers 110, 210 that also are bidirectionally communicatively coupled to network 202. Server 110 hosts one or more websites, and further represents an example of server 110 shown in FIG. 1, and server 210 further represents one or more of the servers 116, 117 shown in FIG. 1. In one example embodiment, the components 115, 118, and 130 of FIG. 1 are included in the network 202, although they need not be and can be included elsewhere in the system 200. Communications between the appliances 150 and one or more of the servers 110, 210 can be monitored by the traffic sniffing device 118 of FIG. 1, in one example embodiment.

It should be noted that at least part of the systems 100 and 200 described above can include wireless or wireline networks, or a combination wireless/wireline networks, and can be used in conjunction with, for example, mobile network operators and multiple service operators (e.g. cable providers).

Having briefly described the networks of FIGS. 1 and 2, a procedure according to example embodiments herein will now be described.

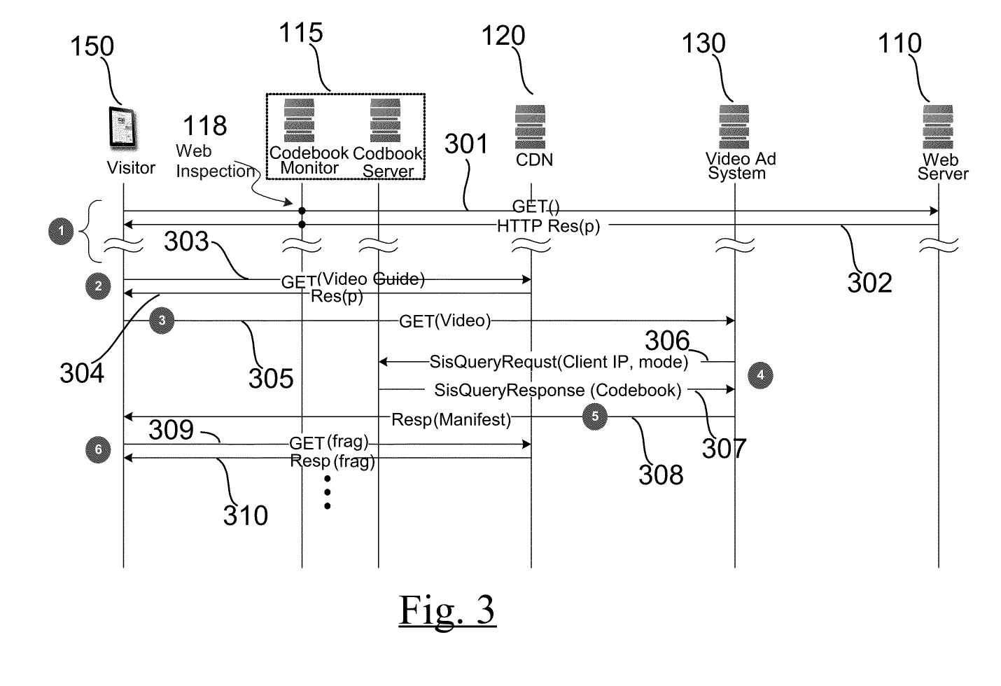

An example interaction diagram representing the procedure is shown in FIG. 3, which will now be described with reference also being made to FIG. 1. This example is described in the context of a VoD scenario, employing message exchange for video playback using cross channel (data to video) addressable advertising.

The procedure proceeds as follows (the numbers below identify the corresponding procedures in FIG. 3). In procedure 301, a user agent running on a user terminal 150 issues a request (in one example, a HTTP request such as a GET request), towards a website (i.e., the web server 110 hosting the website), and in response the requested information is provided by the server 110 to the appliance 150 and presented to the visitor (procedure 302). For example, procedure 301 may be invoked one or more times (although only one is represented in FIG. 3, for convenience) while the subscriber browses one or more webpages on the worldwide web, and, as a result, the server 110 provides the webpage(s) content (e.g., web content relating to pets or some other content) to the appliance 150 for each invocation in procedure 302.

During procedures 301 and 302, the device 118 inspects traffic passing between the elements 150 and 110 in the respective directions indicated, in the above-described manner. As described above, the inspection can occur at one or more protocol layers (e.g., one or more of the GTP, IP, TCP, HTTP, and HTML protocol layers, or other predetermined layers of interest), such as Layer 4 and/or Layer 7 of the HTTP protocol layer. The device 118 identifies in the traffic both an identity of the subscriber and an identity of the server 110 hosting the site visited by the subscriber, and also tracks webpages visited by the subscriber, based on identifier information included in the traffic, as described above. The information obtained by the traffic sniffing device 118 is provided to the internet profile device 115, which operates as described above to classify the webpage(s) determined to be visited in a particular codebook category, and the like, for each particular invocation, and to create and/or update a subscriber interest profile for the subscriber in the above-described manner.

When at some time the subscriber operates the appliance 150 to specify that other content be selected for presentation on the appliance 150, such as, for example, a landing page for selecting video content (e.g., this may be from a video source, such as a video program guide, a webpage, etc.), the information appliance 150 responds in procedure 303 by sending a request (e.g., a GET request) to a content delivery network (CDN) 120 to request retrieval of the landing page. In one illustrative example, the CDN 120 further represents the system 116 of FIG. 1, and the landing page presented includes various selectable items, such as selectable VoD videos. The CDN 120 then responds in procedure 304 by providing the requested landing page to the appliance 150 for presentation to the visitor.

The visitor then operates the appliance 150 to select particular content on the landing page, such as, for example, a particular video. The appliance 150 then responds to the selection by providing a request (e.g., a GET request) to an asset system 130, such as a video ad system (procedure 305), which then responds by issuing a query (e.g., a SisQueryRequest (ClientiP, mode)) to interest profile device 115 (procedure 306). The query includes an identification of the specific visitor by supplying, for example, the visitor's IP address or another identification of the visitor that was included within the request. The query issued by the system 130 requests from the interest profile device 115 the visitor's codebook information (interest profile). The device 115 then responds by correlating the identification of the subscriber, included in the received query, with corresponding information representing the subscriber stored in or in association with the device 115, and by retrieving the stored codebook information (interest profile) corresponding to that subscriber (and generated in the above-described manner). The device 115 then issues to system 130 a response message (e.g., a SISQueryResponse) containing the subscriber's codebook information (procedure 307).

After the system 130 receives the response message in procedure 307, it employs the codebook information included in the message to select particular content stored in or in association with the system 130, such as, for example, one or more available advertisements, by correlating the codebook information with a product category and asset content (e.g., a URL or other link to an advertisement). As one illustrative and non-limiting example, in a case where the codebook information specifies a codebook category relating to shopping for pets (“Shopping—Pets”), then the system 130 selects 30APur.wmv (from the Table 2 described above), which is a link to at least one advertisement relating to shopping for pets. The selected content is then provided to the appliance 150 (procedure 308). The appliance 150 also communicates with network 120 (procedure 309) to retrieve video fragments (procedure 310). Retrieval of the content (e.g., advertizing content) to enable video playback to occur (i.e., the content provided from server 120 is presented to the subscriber, and to enable the content forwarded in procedure 308 to be presented by way of the information appliance 150 such that it is inserted into the video playback in a known manner). In this manner, a personalized pre-roll ad, such as a video advertisement, is chosen and presented to the subscriber based on the subscriber's recent browsing history. Simultaneously or otherwise, other visitors on different information appliances can be provided with pre-roll advertisements that are personalized to their recent browsing behavior, in a similar manner as described above. In one example, each visitor's experience may be independent of the others' experiences, and is personalized to their browsing history.

If, after viewing the video and advertisement, the subscriber returns to the web to visit several additional websites such as, for example sports-related websites (procedures 301, 302), and then selects the same video watched previously (procedure 303), then this time the pre-roll advertisement selected by virtue of procedures 306, 307 and provided to the subscriber 150 in procedure 308 may be for a sports-related advertisement.

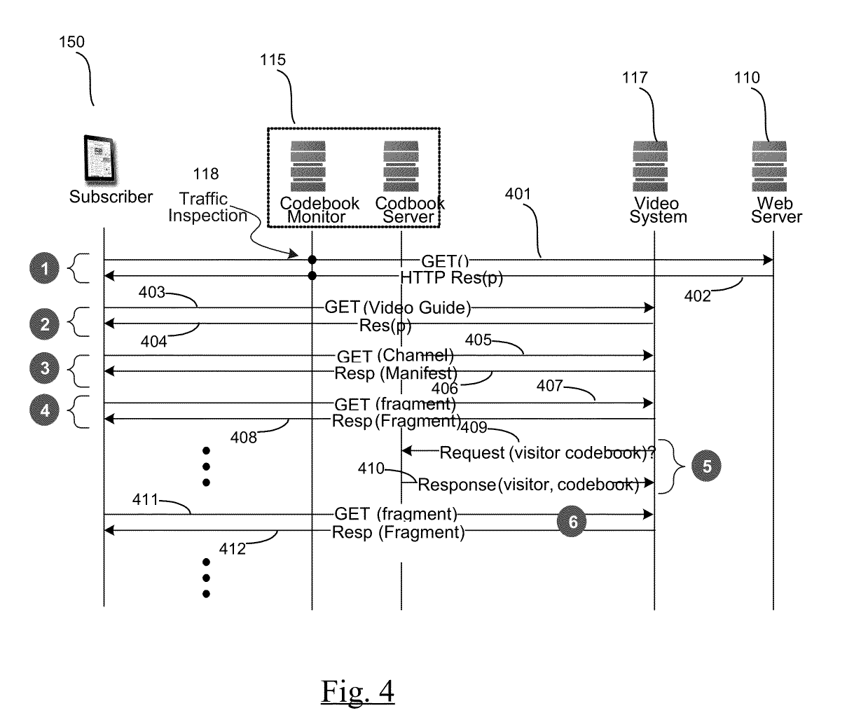

Another example interaction diagram in accordance with another example aspect herein will now be described, with reference to FIGS. 1 and 4. The following example scenario illustrates a message exchange for addressable advertising in an ABR implementation of a linear video environment using the cross channel capability. In this example, advertising content is described in the context of being provided by the video system 117 instead of asset system 130 of FIG. 1, although the content can instead be provided by system 130 in other embodiments, or by another component. It should be noted that although the present example is described in the context of an ABR implementation of a linear video environment, it also is within the scope of the invention to employ the functionalities and procedures described herein in a linear environment that is not an ABR implementation, and/or in non-linear video environments, and/or in a combination linear (where video is “pushed”)/non-linear (where video is “pulled”) video environment.

In procedure 401, a user agent running on a user terminal 150 issues a request (in one example, a HTTP request such as a GET request), towards a website (i.e., the web server 110 hosting the website), and in response the requested information is provided by the server 110 to the appliance 150 and presented to the visitor (procedure 402). For example, procedure 401 may be invoked one or more times (although only one is represented in FIG. 4, for convenience) while the subscriber browses one or more webpages on the worldwide web, and, as a result, the server 110 provides the webpage(s) content (e.g., web content relating to pets or some other content) to the appliance 150 for each invocation in procedure 402.

During procedures 401 and 402, the device 118 inspects traffic passing between the elements 150 and 110 in the respective directions indicated, in the above-described manner. The information obtained by the traffic sniffing device 118 is provided to the internet profile device 115, which operates as described above to classify the webpage(s) determined to be visited in a particular codebook category, and the like, for each particular invocation, and to create and/or update a subscriber interest profile for the subscriber in the above-described manner.

At some time later, the subscriber operates the appliance 150 to specify that other content be selected for presentation on the appliance 150, such as, for example, a landing page for selecting video content. The information appliance 150 responds in procedure 403 by sending a request (e.g., a GET request) to a content system, such as video system 117, to request retrieval of a program guide for channels and videos available (see, e.g., video storefront in FIG. 2. The system 117 then responds in procedure 404 by providing the requested content to the appliance 150 for presentation to the visitor. In one illustrative example, the program guide presented includes various selectable items, such as selectable channels and/or videos.

The subscriber then operates the appliance 150 to select particular content from the program guide, such as, by example only, a linear broadcast channel. The appliance 150 then responds to the selection by providing a request (e.g., a GET request) to system 117 (procedure 405), which then responds by issuing instructions (e.g., a manifest) for playback of the linear video channel selected, to information appliance 150 (procedure 406), which then presents it. In response to the subscriber then operating the appliance 150 to select particular content from the channel, such as, for example, portions of the video (fragments), the appliance 150 responds to the selection by providing a request (e.g., a GET fragment request) to system 117 (procedure 407), which then responds by issuing instructions (e.g., fragment) for playback of the requested content (fragments) selected, to information appliance 150 (procedure 408), which presents the content. The process of exchanging manifest and fragments continues with the system 117 for the duration of the video session. Of course, in environments where video fragments are not employed, the content is provided and presented without the use of fragementations and accompanying instructions.

At some point the subscriber operates the information appliance 150 to request a video (and thus, indirectly or directly, an advertisement), such as at a video program guide, on the web, or elsewhere. The video system 117 then responds in procedure 409 by issuing a query to device 115 (in another example, procedure 409 can be in response to procedure 407). The query includes an identification of the specific subscriber. The query issued by the system 117 in procedure 409 requests from the device 115 the visitor's codebook information (interest profile). The device 115 then responds by correlating the identification of the subscriber, included in the received query, with corresponding information representing the subscriber stored in or in association with the device 115, and by retrieving the stored codebook information (interest profile) corresponding to that subscriber. The server 115 then issues to system 117 a response message containing the subscriber's codebook information (procedure 410).

After the system 117 receives the response message, it employs the codebook information included in the message to select particular content stored in or in association with the system 117, such as, for example, one or more available advertisements, by correlating the codebook information with a product category and asset content (e.g., content that is of greater interest to the subscriber than randomly selected content), as described above. As one illustrative and non-limiting example, in a case where the codebook information specifies a codebook category relating to shopping for pets (“Shopping—Pets”), then the system 117 selects APur.wmv (from the Table 2 described above), which is a link to at least one advertisement relating to shopping for pets.

At some time later, the visitor operates the appliance 150 to select particular content, such as, for example, portions of the video (e.g., in one example, fragments), and the appliance 150 responds to the selection by providing a request (e.g., a GET fragment request) to system 117 (procedure 411), which then responds by issuing instructions (e.g., fragment) for playback of the requested content (fragments) selected, to information appliance 150 (procedure 412), although, as described above, in environments where fragments are not employed, the content can be presented without using fragments and associated instructions. The process of exchanging manifest and fragments continues with the system 117 for the duration of the video session. Procedure 412 can include linear video presentation as well as inserted content (e.g., advertising content from APur.wmv) selected by system 117 as described above. In this manner, a personalized ad is chosen and presented to the subscriber based on its recent browsing history. Simultaneously or otherwise, other visitors on different information appliances can be provided with advertisements that are personalized to their recent browsing behavior, in a similar manner as described above. In one example, each visitor's experience may be independent of the others' experiences, and is personalized to their browsing history.

In one example embodiment, procedure 409 is performed at a predetermined time (e.g., 30 seconds before known breaks in programming, or at predetermined intervals, or the like), as determined by the system 117, and, in procedure 412, the advertisement content is presented at one or more predetermined breaks in the linear video programming provided in procedure 412.

In the example scenarios previously described above, data obtained from the subscriber's data channel is used to provide targeted advertisements on the subscriber's video channel (i.e. cross channel addressable advertising). In other example embodiments, information obtained from a subscriber's non-linear video channel can be used to provide targeted advertisements on the subscriber's linear video channel, and/or vice versa, and that capability also is within the scope if the present invention.

The example aspects described herein are unlike traditional systems which are not geared toward cross-channel functionality and are web based rather than service provider based. Existing solutions also are not cross-channel-based.

The example aspects herein provide a new technology for addressable advertising in the multi-screen video market, enabling monetization of ads inserted into over-the-top (OTT) video streams, including without limitation ad insertion into live program streams on a subscriber device (e.g., an iPad or the like). This technology couples web behavior with on-the-fly television advertising delivery.

The technology enables ad placement decisions based on users' interest categories/profiles while protecting user privacy, and, in one example, can further extend multi-screen targeting and addressability capabilities of existing or later developed advanced advertising platforms.

By virtue of the ad-targeting technology, mobile and pay TV operators can expand into online premium video and mobile advertising opportunities. Users can be provided with relevant ads, while advertisers are enabled to reach their target audiences in more precise and relevant ways, by virtue of the example aspects herein. Video operators may manage centralized ad operations and scale to many insertable channels and ad assets, using increasingly web-centric and virtualized datacenters.

It should be noted that although described in the context of data and video services, the scope of the invention is not limited only thereto. For example, in other embodiments, the cross-channel functionality can be provided using other service combinations besides that described above, such as, without limitation, data and voice, video and voice, or data and voice.

It should be noted that the network configurations represented in FIGS. 1 and 2 are merely illustrative in nature, and should not be construed as being limiting to the scope of the invention. For example, although an asset system 130 is shown in FIG. 1, the functionality of that system can be provided at other parts of the system, such as one or more other components shown in FIG. 1 or elsewhere, such as in a private network, a service provider server, or otherwise. Also, in other embodiments, the networks may have other configurations than those shown in FIGS. 1 and 2, and the interfaces between the depicted equipment may be different than those described above. It also should be noted that the information appliances (subscribers) 150 described herein may include, for example, remote personal computers, handheld personal digital assistants with wireless capability, cellular phones, pagers, set top boxes, and any other suitable types of information appliances. The number and variety of them which may be communicating through the network 100, 200 can vary widely, depending upon the size of the enterprise providing network 100, 20, its needs, users' needs and geographic location(s), applicable design/system operating criteria, etc.

The devices and/or servers described herein may be, in one non-limiting example, a computer or farm of computers that facilitate the transmission, storage, and reception of such information and other data between different points. From a hardware standpoint, in one example a server computer will typically include one or more components, such as one or more microprocessors (also referred to as “controllers”) (not shown), for performing the arithmetic and/or logical operations required for program execution. Also in one example, a server computer will also typically include disk storage media (also referred to as a “memory”), such as one or more disk drives for program and data storage, and a random access memory, for temporary data and program instruction storage. From a software standpoint, in one example a server computer also contains server software resident on the disk storage media, which, when executed, directs the server computer in performing its data transmission and reception functions. As is well known in the art, server computers are offered by a variety of hardware vendors, can run different operating systems, and can contain different types of server software, each type devoted to a different function, such as handling and managing data from a particular source, or transforming data from one format into another format.

Reference is now made to FIG. 7, which is an architecture diagram of an example data processing system 700, which in one example embodiment, can further represent individual ones of the components of FIGS. 1 and 2 (e.g., 150, 110, 114, 115, 116, 118, 117, 130, 210). Data processing system 700 includes a processor 702 coupled to a memory 704 via system bus 706. Processor 702 is also coupled to external Input/Output (I/O) devices (not shown) via the system bus 706 and an I/O bus 708, and at least one input/output user interface 718. Processor 702 may be further coupled to a communications device 714 via a communications device controller 716 coupled to the I/O bus 708. Processor 702 uses the communications device 714 to communicate with other elements of a network, such as, for example, network nodes, and the device 714 may have one or more input and output ports. Processor 702 also can include an internal clock (not shown) to keep track of time, periodic time intervals, and the like.

A storage device 710 having a computer-readable medium is coupled to the processor 702 via a storage device controller 712 and the I/O bus 708 and the system bus 706. The storage device 710 is used by the processor 702 and controller 712 to store and read/write data 710a, as well as computer program instructions 710b used to implement the procedure(s) described above and shown in the accompanying drawing(s) herein (and, in one example, to implement the functions represented in FIGS. 3 and/or 4. In operation, processor 702 loads the program instructions 710b from the storage device 710 into the memory 704. Processor 702 then executes the loaded program instructions 710b to perform any of the example procedure(s) described herein, for operating the system 700.

I/O modules 720 that interconnect with the I/O bus 708 provide interfaces that allow the system to interconnect with other devices via one or more LANs, WANs, or other types of networks.

In some realizations, such as for device 118, inspection modules 722 that interconnect with the system bus 706, are used to inspect data passing there-through at one or more protocol layers (e.g., one or more of the GTP, IP, TCP, HTTP, and HTML protocol layers, or other predetermined layers of interest).

In some realizations, storage modules 724 that interconnect with the system bus 706 and/or I/O bus 708 are used for storage and retrieval of content record. The storage modules may be realized using additional memory, solid state disk drives, rotational media, or the like.

In some example embodiments, one or more of the functions represented in FIGS. 3 and/or 4 can be realized in one or more of the components shown in FIG. 7.

In the foregoing description, example aspects of the invention are described with reference to specific example embodiments thereof The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium”, “machine readable medium”, or “memory” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs. Indeed, the numbered parts of the above-identified procedures represented in the drawings may be representative of operations performed by one or more respective modules, wherein each module may include software, hardware, or a combination thereof.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

In addition, it is not necessary that the procedures performed by the analysts be done with a computer, and instead they can be performed by a human operator.

Although example aspects of this invention have been described in certain specific embodiments, many additional modifications and variations would be apparent to those skilled in the art. It is therefore to be understood that this invention may be practiced otherwise than as specifically described. Thus, the present example embodiments, again, should be considered in all respects as illustrative and not restrictive.

1. A computer-implemented procedure for selecting targeted video content, the procedure comprising:
monitoring web browsing data transmitted between a user device and a server via a first provider service, the web browsing data including a plurality of different websites;
categorizing each of the plurality of different websites into one of a plurality of predefined codebook categories;
generating user profile information based upon the categorized plurality of different websites; and
selecting targeted video content, for display via a second provider service, based upon the user profile information.

2. The procedure of claim 1, further comprising:
providing the targeted video content to the user device or a further user device via the second provider service; and
displaying the targeted video content on the user device or the further user device.

3. The procedure of claim 1, wherein the first provider service is a data service, and the second provider service is a video service.

4. The procedure of claim 2, wherein the targeted video content is displayed in conjunction with one of a video on demand (VoD) video and a linear video.

5. (canceled)

6. The procedure of claim 1, wherein the first provider service is provided over a first channel, and the second provider service is provided over a second channel.

7. (canceled)

8. The procedure of claim 1, further comprising:
providing, in response to a request to display video content, the user profile information to a server which stores video content.

9. The procedure of claim 1, further comprising:
providing, at one or more predetermined times, the user profile information to a server which stores video content.

10. The procedure of claim 1, wherein the targeted video content includes advertising content.

11. The procedure of claim 1, wherein the selecting includes correlating the user profile information to the targeted video content.

12. The procedure of claim 1, wherein the user profile information identifies a codebook category associated with websites most often visited by a user.

13. The procedure of claim 1, wherein a history of web browsing activity is not stored.

14. A targeted video content selection system, comprising:
at least one apparatus arranged to:
monitor web browsing data transmitted between a user device and a server via a first provider service, the web browsing data including a plurality of different websites;
categorize each of the plurality of different websites into one of a plurality of predefined codebook categories;
generate user profile information based upon the categorized plurality of different websites; and
select targeted video content, for display via a second provider service, based upon the user profile information.

15. The system of claim 14, wherein the first provider service is a data service, and the second provider service is a video service.

16. (canceled)

17. The system of claim 14, wherein the first provider service is provided over a first channel, and the second provider service is provided over a second channel.

18. (canceled)

19. The system of claim 15, wherein the targeted video content includes advertising content.

20. An apparatus operating in a communication network and for selecting targeted video content, the apparatus comprising:
at least one communication interface arranged to receive web browsing data transmitted between a user device and a server via a first provider service, the web browsing data including a plurality of different websites; and
at least one processor coupled to the at least one communication interface, and arranged to:
monitor the received web browsing data transmitted between the user device and the server via the first provider service;
categorize each of the plurality of different websites into one of a plurality of codebook categories;
generate user profile information based upon the categorized plurality of different websites; and
select targeted video content, for display via a second provider service, based upon the user profile information.

21. The apparatus of claim 20, wherein the first provider service is a data service, the second provider service is a video service, and the targeted video content includes advertising content.

22. The apparatus of claim 20, wherein the first provider service is a linear or non-linear video service, and the second provider service is a linear or non-linear video service.

23. The apparatus of claim 20, wherein the first provider service is a data service, and the second provider service is a linear or non-linear video service.

24. The procedure of claim 1, wherein the first provider service and the second provider service are provided by the same service provider.
